(19) United States
(12) Patent Application Publication
(10) Pub. No.: US 2018/0274811 A1
(43) Pub. Date: Sep. 27, 2018

(54) Sealed Drive Slip

(71) Applicant: Ductmate Industries, Inc., Monongahela, PA (US)

(72) Inventor: Jason E Marr, Belle Vernon, PA (US)

(73) Assignee: Ductmate Industries, Inc., Monongahela, PA (US)

(21) Appl. No.: 15/927,757

(22) Filed: Mar. 21, 2018

Related U.S. Application Data
(60) Provisional application No. 62/476,294, filed on Mar. 24, 2017.

(51) Int. Cl. F24F 13/02; B21C 37/10; B21D 39/02; F16J 15/08; F16L 23/12

(52) U.S. Cl. CPC F24F 13/0209; B21C 37/101; F16L 23/12; F16J 15/0881; B21D 39/02

(57) ABSTRACT

This invention provides for a sealed drive slip that may be roll-formed from sheet metal. The sealed drive slip has a gasket on the flat portion of the sheet metal and prevents air leakage between the inside and outside of the air duct.

### CROSS-REFERENCE TO RELATED APPLICATIONS

This application claims the benefit of U.S. provisional patent application No. 62/476,294 filed Mar. 24, 2017, which is hereby incorporated by reference in its entirety.

### BACKGROUND OF THE INVENTION

### Field of the Invention

This is invention relates to HVAC duct joints and couplings. In particular it relates to drive slips.

### Description of Related Art

The current standard for securing two pieces of ductwork together at their abutting drive folds is this use of a metal sleeve that slides over the outside of the drive fold, sometimes called drive cleats, drive clips, or drive slips (henceforth called drive slips as it pertains to this disclosure). They come in standard shapes including “S”, “C”, and others. The standard “C” drive slip has the cross-sectional appearance of a “C” compressed along its vertical axis, having tight top and bottoms curves. The standard “C” drive slip used has been on the market for many years, and do not come with a sealant. Application of a sealant prior to installation would result in removal or disruption of the sealant and a non-uniform and/or messy installation process. Thus, if sealing is required, an installer will seal the joint manually. Otherwise, the connections remain unsealed and leak air.

### SUMMARY OF THE INVENTION

In one aspect, the present invention provides a sealed drive slip that may be used to connect and seal ductwork together. The sealed drive slip disclosed herein may be fashioned from a strip of sheet metal, the sealed drive slip having a main flat portion, two curved portions on the edges of the flat portion, and two securing end portions that curve back toward the center thereby creating two channels and a gap between the two securing end portions. The two end securing portions exist in a plane that meets the plane of the main flat portion at an angle. The angle may be about 25 degrees to about 30 degrees. The sealed drive slip further has a gasket on the flat portion of the sheet metal and the gasket is generally in line with the gap between the securing end portions. As disclosed herein, the sealed drive slip may be fashioned from a metal sheet that is less than 2.125 inches. In some embodiments, it is 1.725 inches. In some embodiments, the gap between the two securing end portions is greater than 0.250 inches. In some embodiments, the gap is between 0.500 inches and 0.625 inches. The gasket may be any thickness, for example, between 0.1200 inches and 0.200 inches. In some embodiments it is 0.1875 inches.

In another aspect the present invention provides a method for connecting ends of ductwork using a sealed drive slip, the method comprising the steps of:
a. installing drive folds on two pieces of ductwork intended to be joined;
b. bringing the two pieces of ductwork together such that the drive folds on the edges to be joined abut; and
c. sliding the sealed drive slip over the abutting drive folds.
   When used to connect and join ductwork together, the sealed drive slip does not require any further sealant for installation to achieve a sufficiently sealed ductwork connection.

### BRIEF DESCRIPTION OF THE DRAWINGS

Further aspects of the present disclosure together with additional features contributing thereto and advantages accruing there from will be apparent from the following description of embodiments of the disclosure which are shown in the accompanying drawing figures wherein:

FIG. 1 shows an end view of a drive slip in the prior art;

FIG. 2 shows one embodiment of an end view of a sealed drive slip;

FIG. 2 shows an end view of the prior art drive slip connected to a duct; and

FIG. 4 shows an end view of the sealed drive slip connected to a duct.

### DETAILED DESCRIPTION OF THE INVENTION

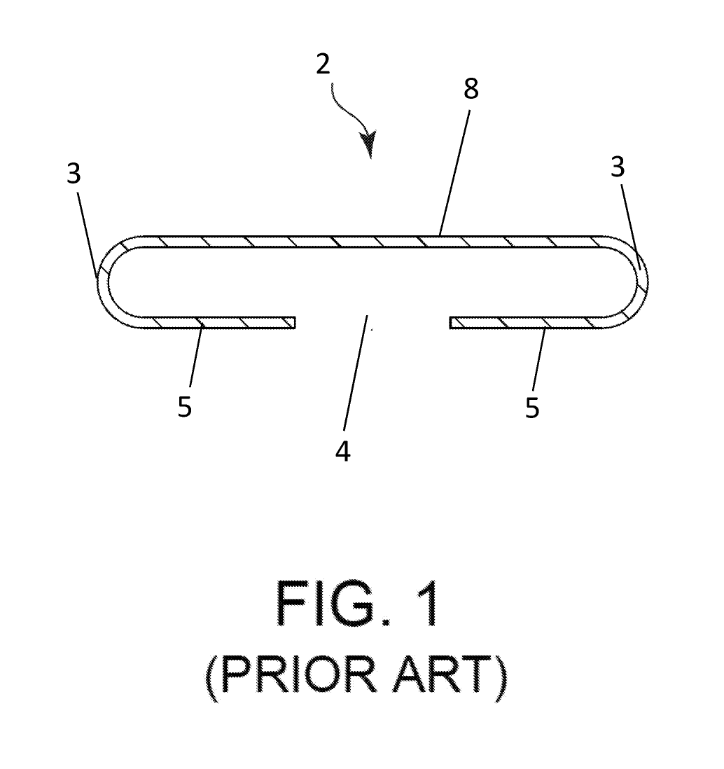

The invention will be described with respect to FIGS. 1 through 4. It should be understood, however, that these figures are an example of a particular embodiment and that there exist many more embodiments that encompass the characteristics disclosed and described herein. While the following description discloses exemplary embodiments, the scope of the present patent application is not limited to the disclosed embodiments, but also encompasses combinations of the disclosed embodiments, as well as modifications to the disclosed embodiments as well as other embodiments.

FIG. 1 illustrates the typical “C” drive slip as discussed in the background section currently in use and being in the prior art. “C” drive slips are long pieces being rolled about the central long axis to form a cross-sectional “C” shape when viewed from the end as shown in FIG. 1. The drive slip 2 as shown is a single piece has no sealant. Those of skill in the art recognize that the drive slip 2 is typically roll-formed from a strip of metal that is typically 2.125 inches wide. The drive slip has a main flat portion 8, two curved portions 3, and two securing end portions 5 separated by a gap 4. Notably, the curvature of the curved portions is high such that the securing end portions 5 are substantially parallel to the main flat portion 8. The finished drive slip 2 typically has a height (the vertical direction in FIG. 1) of 0.1875 inches and width (the horizontal direction in FIG. 1) of 1.125 inches. The gap 4 is small, typically 0.250 inches. Those of skill in the art would recognize that there could be some differences in the measurements depending on the metal thickness and the roll forming machines used to make the parts.

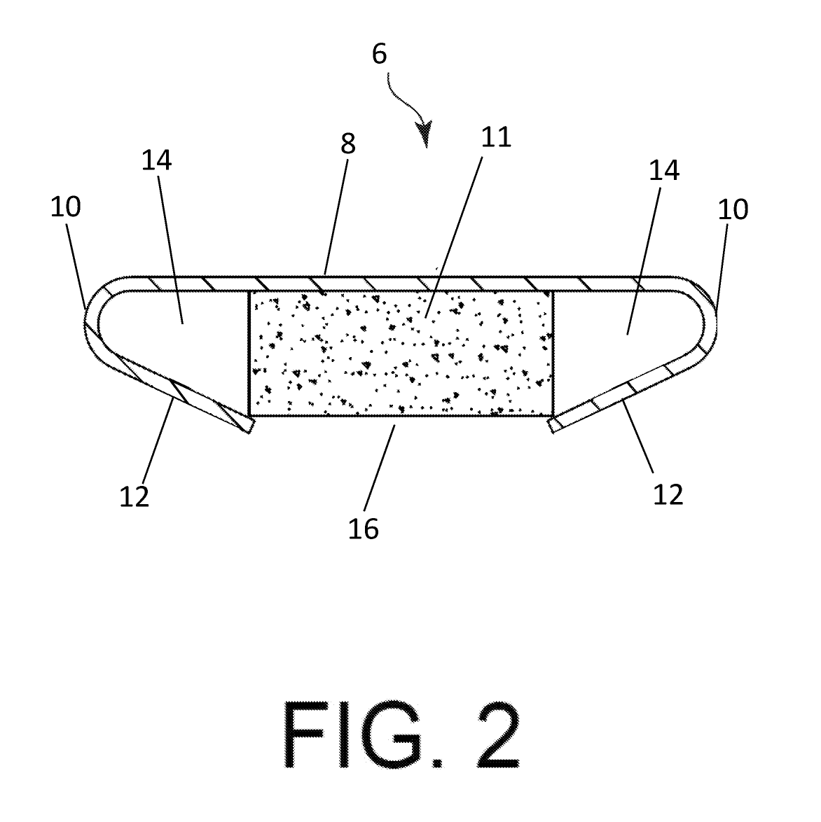

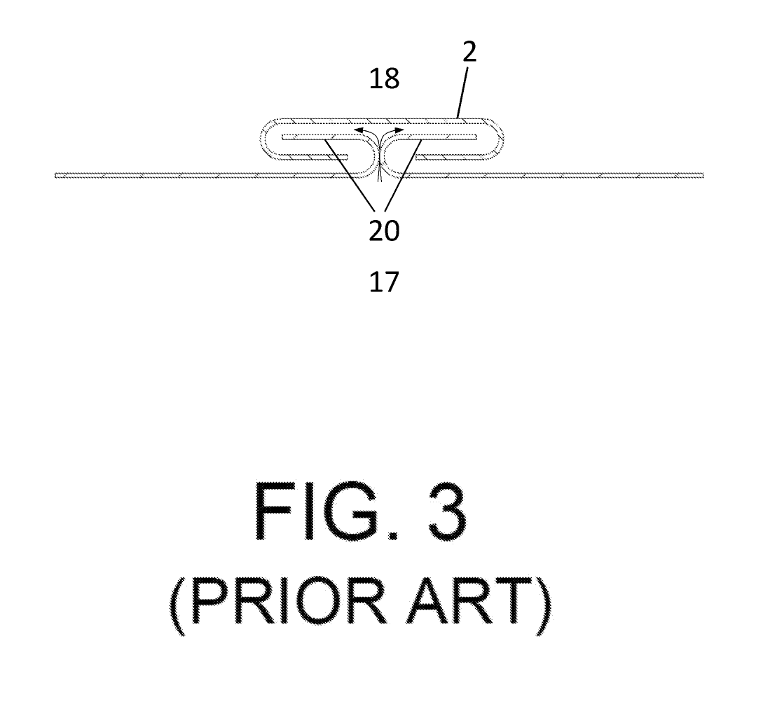

In one aspect, the present invention provides a sealed drive slip. The sealed drive slip may be roll formed from a strip of sheet metal. One embodiment of a sealed drive slip according to the present invention is shown in FIG. 2. The sealed drive slip 6 has a main flat portion 8 and two curved portions 10. The two curved portions 10 have a smaller curvature than the drive slips in the prior art (e.g., FIG. 1) and thus the securing end portions 12 are not substantially parallel to the main flat portion 8, but rather exist in a plane that intersects the plane of the main flat portion 8 at an angle. Within the context of the invention, this angle may be between about 20 degrees and about 45 degrees. In some embodiments, the angle is about 25 degrees to about 30 degrees. The sealed drive slip 6 has a gasket 11 that is substantially centered about the main flat portion 8, creating a channel 14 between the curved portion 10 and the gasket 11. The drive slip also has a gap 16 between the two securing end portions 12. The gasket 11 is generally in line with the gap between the edges of sheet metal.

The sealed drive slip may be manufactured from sheet metal. In contrast to the drive slip commonly used in the art today (e.g., FIG. 1), the sealed drive slip may be rolled from sheet metal less than 2.125 inches wide. In some embodiments, the sealed drive slip is manufactured from sheet metal with a width of 1.725 inches, using substantially less metal than the prior art. In contrast to gap 4 in the prior art (FIG. 1), typically 0.25 inches, the gap 16 in the sealed drive slip may be larger, for example, between about 0.375 inches and about 0.625 inches. In some embodiments, the gap is 0.500 inches. The gasket 11 may be any thickness, for example, from about 0.12 inches to about 0.2 inches. In some embodiments, the gasket 11 is 0.1875 inches. Thus, the height of the sealed drive slip 6 (vertical direction in FIG. 2) may be between the combined thickness of the gasket 11 and the main flat portion, up to a height of about 0.250 inches. The length of the sealed drive slip 6 (a direction going into and out of the plan of FIG. 2) may be any desired length that spans a length equal to the side of the duct on which it is to be installed plus some additional length to further secure the secured drive slip to the ductwork installation. In some embodiments, this may be about 2 inches, but could be longer or shorter, depending on the desired connection strength.

The gasket may be made from materials well-known and often used in the art. For example, the gasket may be rubber based, foams, or other materials often used in the field. Examples of suitable rubber-based materials include EPDM (ethylene propylene diene monomer), neoprene, natural rubbers, polyurethane, santoprene, silicone, urethane, polyethylene, E84 closed cell sponge, vinyl nitride, NBR/PV and/or the like. The gasket could be a factory applied tape with an adhesive, it could be liquid applied and it could be any sealant that allows for sealing of the drive slip. Any material that can compress and be resilient to compensate for the unconformity of the mated edges of the ductwork is suitable and is contemplated as within the scope of the present invention.

The metal used to make the sealed drive slip may be, but is not limited to, galvanized steel, galvannealed steel, aluminized steel, stainless steel, and aluminum.

FIG. 3 illustrates a “C” shaped drive slip from the prior art 2 (e.g., FIG. 1) installed over two flanges 20 in abutting drive folds. Arrows depict where air from inside the duct 17 may leak to the outside of the duct 18. The reverse may also occur, though it is not shown.

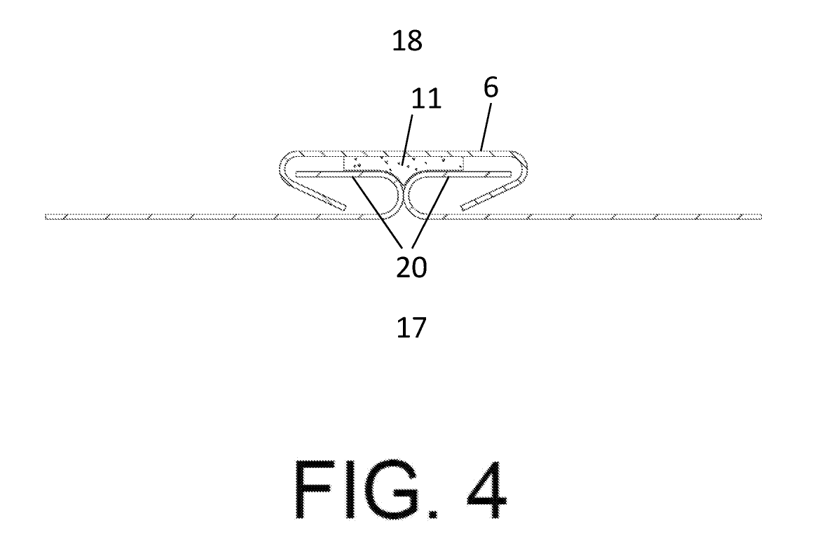

FIG. 4 illustrates a sealed drive slip according to one embodiment of the present invention installed over two flanges 20 in abutting drive folds. Notably, where air was able to leak out of the ductwork as shown in FIG. 3, a gasket 11 fills that space and prevents air leakage.

The systems, apparatus, and methods disclosed herein are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems, apparatus, and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Within the context of the present disclosure, the term “about” when modifying an absolute measurement, such as time, mass, or volume, means the recited value plus or minus 10% of that value. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

In another aspect, the present invention provides a method of connecting and sealing two pieces of ductwork together using a sealed drive slip as disclosed herein. One of skill in the art would readily know how to install drive folds on each piece of ductwork that is to be joined together. Once the drive folds are properly installed, the sealed drive slip may be slid over the drive fold, similar to how drive slips in the prior art are installed. Each end of the sealed drive slip will extend beyond the dimensions of the duct. This extra portion may be bent backwards, for example, with a hammer, to contour to the shape of the duct to secure the sealed drive slip in place.

By utilizing the sealed drive slip as disclosed and provided herein, connections between ductwork may be made that are improved over prior art. The connections may be both strong and air tight as a gasket is incorporated to prevent air leakage. The installation as simple as is presently used in the field and the use of messy sealants is avoided. Further, the sealed drive slip disclosed herein is fashioned from a smaller piece of metal, greatly reducing the amount of metal required to manufacture the part when done so on an industrial scale.

Although various example embodiments have been disclosed, a worker of ordinary skill in this art would recognize that certain modifications would come within the scope of this disclosure. For that reason, the following claims should be studied to determine the scope and content of this disclosure.

We claim:

1. A sealed drive slip for connecting ductwork by connecting to slips on edges of ductwork comprising:
a. a strip of sheet metal having a main flat portion, two curved portions on the edges of the flat portion, and two securing end portions that curve back toward the center thereby creating two channels and a gap between the two securing end portions;
b. an angle where the plane of a securing portion meets the plane of the main flat portion; and
c. a gasket on the flat portion of the sheet metal, the gasket is generally in line with the gap between the securing end portions;
wherein the securing end portions are not substantially parallel to the main flat portion.

2. The sealed drive slip as recited in claim 1 wherein a width of the strip of sheet metal is less than 2.125 inches.

3. The sealed drive slip as recited in claim 2 wherein the width of the strip of sheet metal is about 1.725 inches.

4. The sealed drive slip as recited in claim 1 wherein the gap is greater than 0.250 inches.

5. The sealed drive slip as recited in claim 1, wherein the gap is between 0.500 inches and 0.625 inches.

6. The sealed drive slip as recite in claim 1, wherein the angle is between 25 degrees and 30 degrees.

7. The sealed drive slip as recited in claim 1, wherein the gasket has a height of between 0.1200 inches and 0.200 inches.

8. The sealed drive slip as recited in claim 1 wherein the height of the sealed drive slip is between 0.1875 inches and 0.200 inches.

9. A method for connecting ends of ductwork using a sealed drive slip, the method comprising the steps of:
a. installing drive folds on two pieces of ductwork intended to be joined;
b. bringing the two pieces of ductwork together such that the drive folds on the edges to be joined abut; and
c. sliding the sealed drive slip over the abutting drive folds.

10. The method according to claim 9, wherein no further sealant is used to seal the connection between the pieces of ductwork.
